(19) United States
(12) Patent Application Publication
(10) Pub. No.: US 2024/0292062 A1
(43) Pub. Date: Aug. 29, 2024

(54) VIDEO-BASED INFORMATION DISPLAY METHOD AND APPARATUS, ELECTRONIC DEVICE, AND STORAGE MEDIUM

(71) Applicant: Beijing Youzhuju Network Technology Co., Ltd., Beijing (CN)

(72) Inventors: Ying HUANG, Beijing (CN); Menglin ZHANG, Beijing (CN); Liangcheng XU, Beijing (CN)

(21) Appl. No.: 18/572,646

(22) PCT Filed: Sep. 19, 2022
(86) PCT No.: PCT/CN2022/119629

§ 371 Date: Dec. 20, 2023

(30) Foreign Application Priority Data
Sep. 27, 2021 (CN) 202111137817.X

(51) Int. Cl. H04N 21/4725; H04N 21/431

(52) U.S. Cl. CPC H04N 21/4725; H04N 21/4316

(57) ABSTRACT

A video-based information display method and apparatus, an electronic device and a storage medium. The video-based information display method includes: in a process of playing a target video, displaying, on a playing page of the target video, first resource information corresponding to a target object in the target video, in which the target video includes M image frames, and the first resource information is obtained in advance by matching based on target objects in N image frames; in response to triggering a first event in the process of playing the target video, acquiring second resource information corresponding to a target object in a current image frame based on at least one current image frame played by the playing page in a process of triggering the first event; and displaying the second resource information.

The present application claims the priority of Chinese patent application No. 202111137817.X filed on Sep. 27, 2021, and the above Chinese patent application is incorporated herein by reference in its entirety as part of the present application.

### TECHNICAL FIELD

Embodiments of the present disclosure relate to a video-based information display method and apparatus, electronic device, and storage medium.

### BACKGROUND

In order to facilitate a user to search for content in a picture, some applications provide an image recognition and search function. The user may upload a picture to the application, and the application can recognize the picture and search for relevant content according to a recognition result, and provide the relevant content to the user. If the user wants to search for content in a video while watching the video, the user needs to capture an image of the video and upload the captured image to an image recognition application for recognition and search. Alternatively, in a process of displaying a video or a picture, the application can search and recommend similar content according to the content such as items appearing in the video or the picture.

### SUMMARY

An image recognition and search function for dynamic media resource such as a video is relatively single and the operation is complicated. In view of the above problems, at least one embodiment of the present disclosure provides a video-based information display method and apparatus, electronic device and storage medium, which can enrich the image recognition and search function for the video, simplify an operation flow and improve the user experience.

At least one embodiment of the present disclosure provides a video-based information display method, including: in a process of playing a target video, displaying, on a playing page of the target video, first resource information corresponding to a target object in the target video, in which the target video includes M image frames, and the first resource information is obtained in advance by matching based on target objects in N image frames; in response to triggering a first event in the process of playing the target video, acquiring second resource information corresponding to a target object in a current image frame based on at least one current image frame played by the playing page in a process of triggering the first event; and displaying the second resource information, in which N is an integer greater than 0 and M is an integer greater than or equal to N.

At least one embodiment of the present disclosure further provides a video-based information display apparatus, including a first display unit and a second display unit. The first display unit is configured to, in a process of playing a target video, display, on a playing page of the target video, first resource information corresponding to a target object in the target video, in which the target video includes M image frames, and the first resource information is obtained in advance by matching based on target objects in N image frames. The second display unit is configured to, in response to triggering a first event in the process of playing the target video, acquire second resource information corresponding to a target object in a current image frame based on at least one current image frame played by the playing page in a process of triggering the first event, and display the second resource information. N is an integer greater than 0 and M is an integer greater than or equal to N.

At least one embodiment of the present disclosure further provides an electronic device, including a processor and a memory including one or more computer program modules. The one or more computer program modules are stored in the memory and configured to be executed by the processor, and the one or more computer program modules include instructions for implementing the video-based information display method according to any one embodiment of the present disclosure.

At least one embodiment of the present disclosure further provides a computer-readable storage medium for storing non-transitory computer-readable instructions, non-transitory computer-readable instructions, when executed by a computer, implement the video-based information display method according to any one embodiment of the present disclosure.

At least one embodiment of the present disclosure further provides a computer program product including a computer program carried on a non-transient computer-readable medium, the computer program including program codes for executing the video-based information display method according to any one embodiment of the present disclosure.

### BRIEF DESCRIPTION OF THE DRAWINGS

The above-described and other features, advantages and aspects of the respective embodiments of the present disclosure will become more apparent when taken in conjunction with the accompanying drawings and with reference to the detailed description below. Throughout the drawings, same reference signs refer to same elements. It should be understood that, the drawings are schematic and that originals and elements are not necessarily drawn to scale.

FIG. 1 is a flow diagram of a video-based information display method provided by some embodiments of the present disclosure;

FIG. 2 is a schematic diagram of a playing page of a target video provided by some embodiments of the present disclosure;

FIG. 3 is a schematic diagram of another playing page of a target video provided by some embodiments of the present disclosure;

FIG. 4A is a schematic diagram of another playing page of a target video provided by some embodiments of the present disclosure;

FIG. 4B is a schematic diagram of another playing page of a target video provided by some embodiments of the present disclosure;

FIG. 5 is a schematic diagram of another playing page of a target video provided by some embodiments of the present disclosure;

FIG. 6 is a schematic diagram of a page after a screenshot operation is performed on the playing page according to some embodiments of the present disclosure;

FIG. 7 is a schematic diagram of a page after a first event is triggered according to some embodiments of the present disclosure;

FIG. 8 is a schematic diagram of a resource page provided by some embodiments of the present disclosure;

FIG. 9A is a schematic diagram of a box selection page provided by some embodiments of the present disclosure;

FIG. 9B is a schematic diagram of another resource page provided by some embodiments of the present disclosure;

FIG. 10A is a schematic diagram of a progress page provided by some embodiments of the present disclosure;

FIG. 10B is a schematic diagram of another progress page provided by some embodiments of the present disclosure;

FIG. 11 shows a system that may be used to implement the video-based information display method provided by the embodiment of the present disclosure;

FIG. 12 is a schematic block diagram of a video-based information display apparatus provided by some embodiments of the present disclosure;

FIG. 13 is a schematic block diagram of an electronic device provided by some embodiments of the present disclosure;

FIG. 14 is a schematic block diagram of another electronic device provided by some embodiments of the present disclosure; and

FIG. 15 is a schematic diagram of a storage medium provided by some embodiments of the present disclosure.

### DETAILED DESCRIPTION

Embodiments of the present disclosure will be described in more detail below with reference to the accompanying drawings. Although some embodiments of the present disclosure are shown in the drawings, it should be understood that the present disclosure may be embodied in various forms and should not be construed as limited to the embodiments set forth here, On the contrary, these embodiments are provided for a more thorough and complete understanding of the present disclosure. It should be understood that the drawings and the embodiments of the present disclosure are only for illustration purposes, and are not intended to limit the protection scope of the present disclosure.

It should be understood that the steps described in the method embodiments of the present disclosure may be performed in a different order and/or in parallel. In addition, the method embodiments may include additional steps and/or omit the steps shown. The scope of the present disclosure is not limited in this respect.

As used herein, the term “comprising” and its variations are open including, that is, “including but not limited to”. The term “based on” means “at least partially based on”. The term “one embodiment” means “at least one embodiment”; the term “another embodiment” means “at least one other embodiment”; and the term “some embodiments” means “at least some embodiments”. Relevant definitions of other terms will be given in the following description.

It should be noted that the concepts of “first” and “second” mentioned in the disclosure are only used to distinguish devices, modules or units, and are not used to limit that these devices, modules or units must be different devices, modules or units, nor to limit the order or interdependence of the functions performed by these devices, modules or units.

It should be noted that the modification “one” and “a plurality” mentioned in this disclosure are illustrative rather than restrictive, and those skilled in the art should understand that unless the context clearly indicates otherwise, they should be understood as “one or more”. “a plurality ” should be understood to mean two or more.

The names of interactive messages or information between a plurality of devices in the embodiment of the present disclosure are for illustrative purposes only and should not restrict the scope of the messages or information.

For content recognition and search of a video, one way is to capture an image in the video and upload the captured image to an image recognition platform (for example, an application) for recognition and search, but the operation is complicated, the image recognition and search function for the video is single, and the user experience is poor.

At least one embodiment of the present disclosure provides a video-based information display method and apparatus, electronic device and storage medium, which can enrich the image recognition and search function for the video, simplify an operation flow and improve the user experience.

Hereinafter, embodiments of the present disclosure will be described in detail with reference to the accompanying drawings.

At least one embodiment of the present disclosure provides a video-based information display method. The video-based information display method includes: in a process of playing a target video, displaying, on a playing page of the target video, first resource information corresponding to a target object in the target video, in which the target video includes M image frames, and the first resource information is obtained in advance by matching based on target objects in N image frames; in response to triggering a first event in the process of playing the target video, acquiring second resource information corresponding to a target object in a current image frame based on at least one current image frame played by the playing page in a process of triggering the first event; and displaying the second resource information. N is an integer greater than 0 and M is an integer greater than or equal to N.

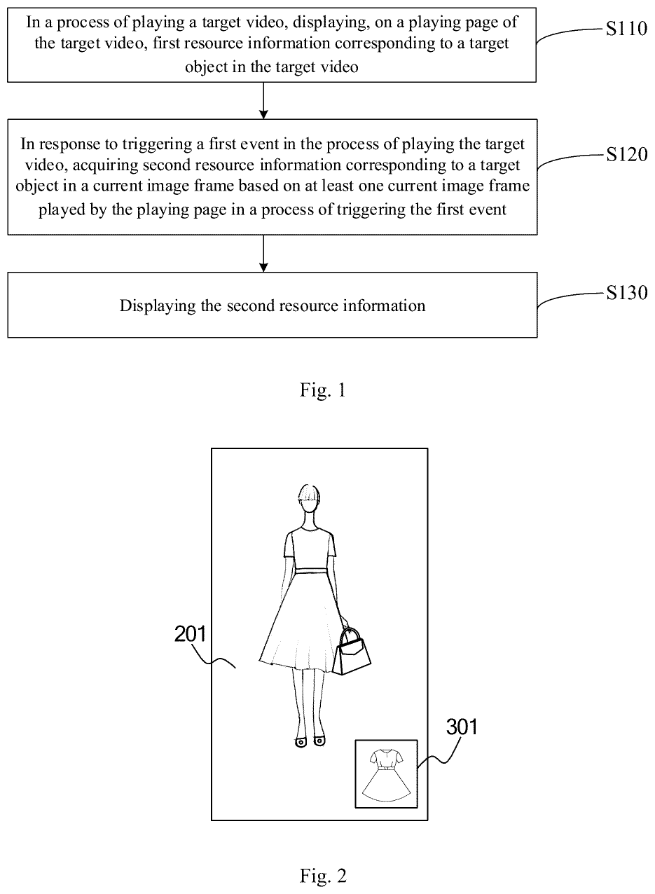

FIG. 1 is a flow diagram of a video-based information display method provided by some embodiments of the present disclosure. As shown in FIG. 1, in at least one embodiment, the method includes the operations of steps S110 to S130 as follows.

Step S110: in a process of playing a target video, displaying, on a playing page of the target video, first resource information corresponding to a target object in the target video.

Step S120: in response to triggering a first event in the process of playing the target video, acquiring second resource information corresponding to a target object in a current image frame based on at least one current image frame played by the playing page in a process of triggering the first event.

Step S130: displaying the second resource information.

For example, the video-based information display method of the embodiment of the present disclosure may be executed by a terminal device, the terminal device includes but not limited to a mobile phone, a tablet computer, a notebook computer and the like. The terminal device may include a display apparatus, a processor, a data transceiver and the like, and the terminal device may transmit data with a server and/or a database through a communication network.

For example, the target video may be a short video, a long video, a live video and other video media resources. The target video may be uploaded to a corresponding platform (for example, an application) by the terminal device, and the target video may be stored in the server and/or the memory of the platform. The terminal device that uploads the target video (for example, a client and a user) may be the same as or different from a device that plays the target video (for example, a client and a user). For example, after a first user uploads a target video to a platform (for example, a server side) through a first terminal device, the platform may, in response to a request, push the target video to a second terminal device to play, so as to be viewed by a second user of a second terminal device.

For example, the target object may include an object such as an item, a person and an animal appearing in the video, and the resource information (for example, the first resource information and the second resource information) may be recommendation information or explanatory information about the target object. In some examples, when the target object is an item (for example, a commodity, an exhibit, etc.), the resource information may be item recommendation information corresponding to the item or explanatory information about the item, etc. In other examples, in a case where the target object is a person, the resource information may be explanatory information about the person. In the following embodiments, for example, taking the target object as an item and the resource information as item recommendation information as an example for illustration, but the embodiment of the present disclosure is not limited to this, and in the actual application process, the types of the target object and the resource information may be set according to actual requirements.

For example, in step S110, the target video includes M image frames, and the first resource information is obtained in advance by matching based on target objects in N image frames, N is an integer greater than 0 and M is an integer greater than or equal to N.

For example, after the target video is uploaded to the server of the platform, the server may perform the recognition and search operation on at least some image frames (that is, N image frames) in the target video, and the recognition and search operation may be performed with a permission from the user. For example, some image frames may belong to a certain video clip in the target video, or may be several key image frames in the target video, the key image frame may be an image frame whose picture difference with its previous image frame exceeds a certain threshold, and the picture difference between different image frames may be determined by the difference of pixel values at a plurality of corresponding positions in different image frames.

For example, the recognition operation on the image frame may be performed by using a pre-trained object recognition model, and the object recognition model may be a neural network model, a classification tree model or other types of models. In a process of training the object recognition model, the object recognition model may be trained to be able to recognize a category and features of the target object in the image frame. For example, in a case where the image frame includes a target object “skirt”, by using the object recognition model, the type of the target item may be recognized as a skirt, and the features of the skirt such as color, length, material and texture may be recognized. For example, one or more target objects may be recognized for each image frame. In the case where one target object needs to be determined for each image frame while the image frame contains a plurality of target objects, one main target object may be determined according to conditions such as occupied area or coordinate position of each target object.

For example, after recognition results of target objects of the N image frames are obtained, a search operation may be performed in a predetermined network platform based on the recognition result of each target object, and resource information matched with each target object may be obtained as the first resource information. For example, in the case where the recognition result of the target object of a certain image frame is a long yellow skirt, the search may be performed in a predetermined shopping platform according to keywords such as “yellow” and “long skirt” to obtain one or more pieces of commodity information matched with the target object. In some examples, in the case where the number of pieces of searched commodity information exceeds a first predetermined amount (the first predetermined amount is, for example, one), a filtering operation may be performed to filter out the first predetermined number of pieces of commodity information from the search results. For example, the target video includes 10 key image frames; if one target object is recognized for each key image frame, 10 target objects may be obtained; if one piece of matched resource information is searched for each target object, 10 pieces of resource information may be obtained, and the 10 pieces of resource information may be used as the first resource information. For the sake of distinction, each piece of resource information in the first resource information is referred to as first sub-resource information hereinafter.

For example, based on step S110, before the target video is played, the server may be used in advance to obtain the first resource information about the target video offline. Thereafter, in the process of playing the target video by the terminal device, the first resource information may be displayed on the playing page of the target video, so that the user may obtain relevant resource information of the target video without an additional search operation.

FIG. 2 is a schematic diagram of a playing page of a target video provided by some embodiments of the present disclosure. As shown in FIG. 2, for example, the first resource information includes commodity information 301 corresponding to the illustrated image frame 201, the commodity information 301 may be displayed in the process of playing the target video, and the commodity information 301 may be implemented as an interface control. For example, when a predetermined operation (such as a click) is triggered on the commodity information 301, the page may jump to a commodity details page corresponding to the commodity information 301.

For example, in step S120, if the first event is triggered in the process of playing the video, online recognition and search operation may be performed on a current image frame being played when the first event is triggered. For example, the terminal device may acquire the current image frame and send the current image frame to the server, and the server performs the recognition and search operation on the current image frame. The recognition and search operation on the current image frame may refer to the above-mentioned recognition and search operation on the N image frames. With respect to the target object in the current image frame, a second predetermined number of pieces of resource information (the second predetermined number is, for example, a numerical value between 10 and 500) may be acquired, and the second predetermined number of pieces of resource information may be used as the second resource information. For the sake of distinction, each piece of resource information in the second resource information is referred to as second sub-resource information hereinafter. After the server acquires the second resource information matched with the target object in the current image frame, the server may send the second resource information to the corresponding terminal device.

For example, in step S130, after receiving the second resource information, the terminal device may display the second resource information. For example, the second resource information may be directly displayed on the playing page, or the terminal device may jump from the playing page to the resource page to display the second resource information on the resource page.

For example, based on steps S120 and S130, online recognition and search operations may be performed on one or some image frames in response to a user operation in the process of playing the target video. Based on this way, when the user sees the target object of interest, the user can acquire the corresponding resource information quickly and conveniently.

According to the video-based information display method of the embodiment of the present disclosure, off-line recognition can be combined with on-line recognition, so that in a case that the user does not trigger the recognition and search operation, the resource information recognized and searched offline is displayed to the user, and when the user triggers the recognition and search operation on the image frame of interest, resource information matched with the image frame of interest to the user may be acquired online. The image recognition and search function for the video can be enriched, the operation process can be simplified and the user experience can be improved.

For example, as shown in FIG. 2, the playing page includes a first display region (for example, a box region indicated by reference numeral 301 in FIG. 2), and the first resource information may be displayed in the first display region. The first resource information includes N pieces of first sub-resource information respectively corresponding to the target objects in the N image frames. For example, for the target object in each key image frame, one piece of sub-resource information may be obtained by matching.

For example, the displaying, on a playing page of the target video, first resource information corresponding to a target object in the target video in step S110 includes: respectively displaying the N pieces of first sub-resource information in the first display region when the N image frames are respectively displayed on the playing page.

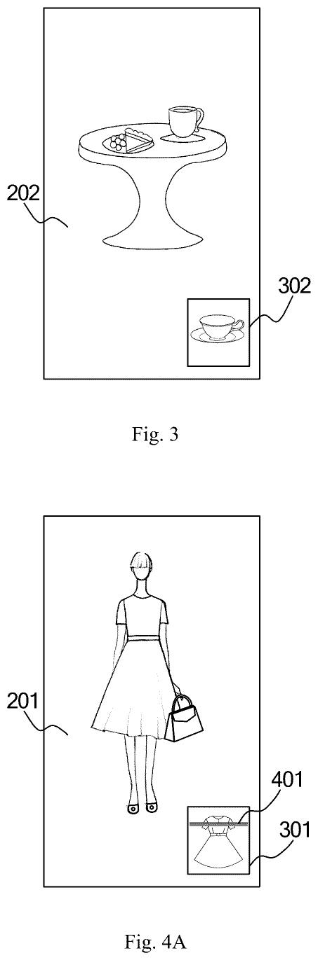

FIG. 3 is a schematic diagram of another playing page of a target video provided by some embodiments of the present disclosure. As shown in FIGS. 2 and 3, the first resource information may include commodity information 301 corresponding to the image frame 201 shown in FIG. 2 and commodity information 302 corresponding to the image frame 202 shown in FIG. 3. Commodity information 301 may be displayed in the first display region when the playing page is played to the image frame 201, and commodity information 302 may be displayed in the first display region when the playing page is played to the image frame 202. That is to say, when the playing page is played to each of the N image frames, the first sub-resource information matched with the image frame is displayed on the playing page, and the displayed first sub-resource information will change with the change of the playing progress. Based on this way, the resource information may correspond to the image frame on the playing page, so that an interface can be more concise and the user can conveniently view the first sub-resource information of interest.

For example, the N image frames include an i-th image frame and a j-th image frame, and the first resource information includes i-th first sub-resource information corresponding to the i-th image frame and j-th first sub-resource information corresponding to the j-th image frame, i is an integer greater than 0, and j is an integer greater than i and less than M. For example, the displaying, on a playing page of the target video, first resource information corresponding to a target object in the target video in step S110 includes: in a process of displaying the i-th image frame and an image frame between the i-th image frame and the j-th image frame on the playing page, displaying the i-th first sub-resource information in the first display region.

For example, the i-th image frame is the image frame 201 shown in FIG. 2, the j-th image frame is the image frame 202 shown in FIG. 3, and the first resource information includes commodity information 301 corresponding to the image frame 201 shown in FIG. 2 and commodity information 302 corresponding to the image frame 202 shown in FIG. 3. While the playing page plays the image frame 201, the commodity information 301 is displayed in the first display region, the commodity information 301 may be continuously displayed in the first display region for a period of time until the playing page plays the image frame 202, and the commodity information in the first display region may be replaced from the commodity information 301 to the commodity information 302. That is to say, in the process of playing image frames between two adjacent key image frames, first sub-resource information corresponding to the previous key image frame of the two adjacent key image frames may be continuously displayed until the next key image frame is played. Because the middle image frames between two adjacent key image frames are less different from the previous key image frame, there is a high probability that the middle image frames correspond to the same first sub-resource information as the previous key image frame. Therefore, the previous first sub-resource information may be continuously displayed in the process of playing the middle image frames, and it basically ensures that the playing picture is matched with the first sub-resource information in the whole process of playing the target video.

For example, in other examples, all the first sub-resource information contained in the first resource information may be displayed on the playing page during the whole process of playing the target video, and the user may select first sub-resource information of interest to view.

For example, the M image frames further include a p-th image frame between the i-th image frame and the j-th image frame, and p is an integer greater than i and less than or equal to j. The information display method may further include: in the process of displaying the i-th image frame and an image frame between the i-th image frame and the p-th image frame on the playing page, displaying, on the first display region, a first scanning graphic that changes as image frames displayed on the playing page change.

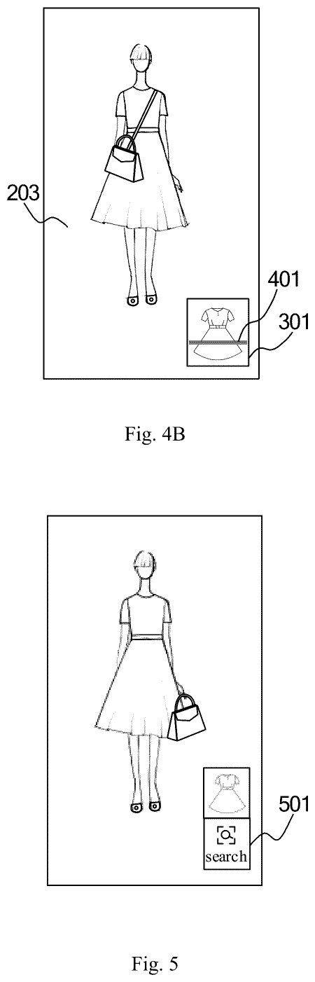

FIG. 4A is a schematic diagram of another playing page of a target video provided by some embodiments of the present disclosure, and FIG. 4B is a schematic diagram of another playing page of a target video provided by some embodiments of the present disclosure.

As shown in FIGS. 2, 3, 4A and 4B, following the above example, for example, the i-th image frame is the image frame 201 shown in FIGS. 2 and 4A, the j-th image frame is the image frame 202 shown in FIG. 3, the p-th image frame is the image frame 203 shown in FIG. 4B, and the image frame 203 is between the image frame 201 and the image frame 202. When the playing page is played to the image frame 201, the first scanning graphic 401 may appear in the first display region; and in the process of playing from the image frame 201 to the image frame 203, the first scanning graphic 401 is continuously displayed in the first display region, and during this period, the first scanning graphic 401 changes with the continuous change of the playing picture, which can also be understood as that the first scanning graphic 401 changes over time. For example, as the image frames displayed on the playing page change, at least a portion of the first scanning graphic moves in the first display region in a predetermined direction, the predetermined direction may be a longitudinal direction of the playing page (e.g., the up-down direction in FIGS. 4A and 4B), to present a scanning effect.

For example, the first scanning graphic 401 may not be displayed in the process of playing from the image frame 203 to the image frame 202, and new first sub-resource information appears on the playing page when playing to the next key image frame (i.e., the image frame 202), at this time the first scanning graphic 401 may appear again, the first scanning graphic 401 disappears after moving scanning for a period of time, and the first scanning graphic 401 appears again when the page is played to another key image frame, and so on, until the target video is played to the end. That is to say, each time one piece of new first sub-resource information appears on the playing page, the first scanning graphic may appear simultaneously and moves to scan for a period of time. Based on this way, the first scanning graphic may be used to indicate that the new first sub-resource information is emerging, so as to attract the attention of the user and prompt the user to check the newly emerging first sub-resource information.

For example, the first scanning graphic 401 may be linear, curved, box-shaped, dotted and so on, and may be specifically set according to actual requirements, which is not limited by the embodiment of the present disclosure. The first scanning graphic 401 may move in the up-down direction, or in a left-right direction, or in an oblique direction. In addition to adopting a change mode of moving, in other examples, the change mode of the first scanning graphic may be rotating, flashing, deforming, etc.

FIG. 5 is a schematic diagram of another playing page of a target video provided by some embodiments of the present disclosure. As shown in FIG. 5, for example, the video-based information display method of the embodiment of the present disclosure may further include: In the process of playing the target video, the first control 501 is displayed on the playing page of the target video. In some examples, the triggering a first event in the process of playing the target video in step S120 includes: triggering a first predetermined operation on the first control 501 in the process of playing the target video.

For example, the first predetermined operation may be a click operation. In the process of playing the target video, the first control 501 is displayed on the playing page, and in the case where the user is interested in the target object in a certain image frame, the user may click on the first control 501 to trigger the online recognition and search operation on the image frame. In other examples, the first predetermined operation may also be a double-click operation, a swipe operation, etc., and the embodiment of the present disclosure does not limit the specific form of the first predetermined operation.

For example, in other examples, the triggering a first event in the process of playing the target video in step S120 may include: triggering a playing pause operation on the target video in response to the first event.

For example, the first event may be an event that can trigger a play pause, and the play pause may be triggered, for example, by clicking on a pause key or by clicking on a certain region of the playing page. In the process of playing the target video, in the case where the user is interested in the target object in a certain image frame, the user may pause the target video, which may trigger the online recognition and search operation on the image frame.

For example, in other examples, the triggering a first event in the process of playing the target video in step S120 may include: triggering a screenshot operation on the playing page of the target video in response to the first event.

For example, the first event may be an event that may trigger a screenshot, and the screenshot may be triggered, for example, by pressing a specific key. In the process of playing the target video, in the case where the user is interested in the target object in a certain image frame, the user may perform the screenshot operation, which may trigger the online recognition and search operation on the image frame.

For example, the three ways for triggering online recognition and search operation (namely, using the first control, the pause and the screenshot) described above are simple and easy to operate and implement, and the ways for triggering the online recognition and search operation may be more diversified to adapt to the different operation habits of different users, thereby improving the user experience.

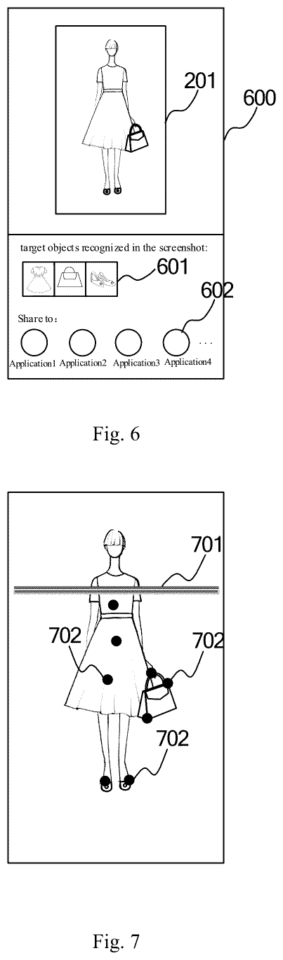

FIG. 6 is a schematic diagram of a page after a screenshot operation is performed on the playing page according to some embodiments of the present disclosure. As shown in FIG. 6, for example, the video-based information display method of the embodiment of the present disclosure may further include: displaying a second control 601 and a third control 602 in response to the screenshot operation on the playing page of the target video, the second control 601 is configured to trigger an operation of displaying the second resource information, and the third control 602 is configured to trigger an operation of sharing the target video to a platform or a user corresponding to the third control 602.

For example, the screenshot operation is triggered when the playing page is played to the image frame 201, then the playing page may jump to a sharing page 600, and the second control 601 and the third control 602 may be displayed on the sharing page 600. The second control 601 may be a control about the second resource information matched with the image frame 201. For example, the second resource information matched with the image frame 201 includes several pieces of second sub-resource information (for example, commodity information such as “skirts”, “bags” and “shoes”), a second control 601 may be displayed for each second sub-resource information, and when the user clicks on any second control 601, the page may jump to a details page of the corresponding second sub-resource information. The third control 602 may be a platform sharing control, and when the user clicks on any platform sharing control, the page may jump to the corresponding platform to perform a sharing operation. The third control 602 may also be a user sharing control, and when the user clicks on any user sharing control, the page may jump to a sharing interface for sharing with a corresponding user. The purpose of executing the screenshot operation may be to share the screenshot, or to trigger the recognition and search operation on the current image frame. When the intention of the user cannot be determined, two controls are displayed for the user to choose, so that misoperation can be avoided.

FIG. 7 is a schematic diagram of a page after a first event is triggered according to some embodiments of the present disclosure. As shown in FIG. 7, for example, the video-based information display method of the embodiment of the present disclosure may further include: in a process of obtaining the second resource information, displaying the current image frame on the playing page, and displaying a dynamic second scanning graphic superimposed on the current image frame. The dynamic second scanning graphic may include a first sub-scanning graphic 701 moving in a predetermined direction and/or a second sub-scanning graphic 702 moving or flashing at a position of the target object in the current image frame.

For example, in the case where the first event is triggered when the page is played to the image frame 201 shown in FIG. 2, the page may stay in the image frame 201, and in a process of waiting for the server to perform the recognition and search operation, the first sub-scanning graphic 701 may be displayed in the page, and the first sub-scanning image may move in a predetermined direction (for example, the up-down direction as shown) to present a scanning effect. After the server determines second sub-resource information matched with each target object of the image frame 201, the server may send each second sub-resource information and position information of each target object to the terminal device, the terminal device may display the second sub-scanning graphic 702 at the position where each target object is located, the second sub-scanning graphic 702 may be presented in a dynamic manner such as moving or flashing to indicate that the target objects are found at these positions and relevant second sub-resource information is searched, and subsequently each second sub-resource information may be presented.

For example, the displaying the second resource information in step S130 may include: displaying a resource page, and displaying the second resource information in the resource page. The current image frame includes E target objects, and the second resource information includes a plurality of pieces of second sub-resource information respectively corresponding to the E target objects. The resource page may include a second display region and E fourth controls respectively corresponding to the E target objects, and each of the fourth controls is configured to trigger an operation of displaying second sub-resource information corresponding to the fourth control in the second display region, E being an integer greater than 0.

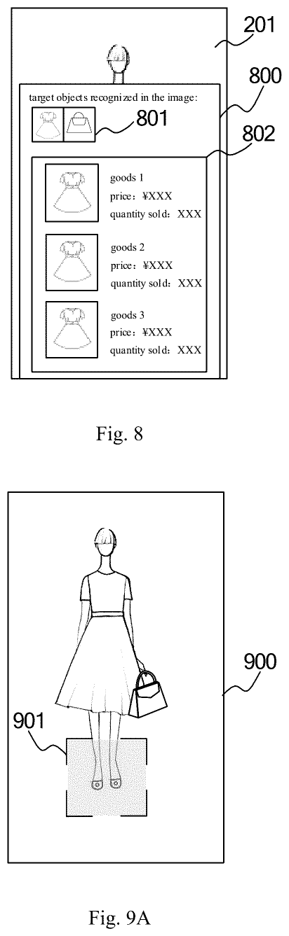

FIG. 8 is a schematic diagram of a resource page provided by some embodiments of the present disclosure. As shown in FIG. 8, for example, in the case where the first event is triggered when the page is played to the image frame 201 shown in FIG. 2, a resource page 800 may be displayed after the second sub-resource information matched with each target object of the image frame 201 is obtained, and the resource page 800 may be displayed superimposed on the image frame 201 or the playing page may jump to a single resource page 800. For example, two target objects, namely a skirt and a bag, are recognized for image frame 201, and a plurality of pieces of second sub-resource information may be searched for each target object. The resource page 800 may include a second display region 802 and two fourth controls 801 respectively corresponding to two target objects, and a plurality of pieces of corresponding second sub-resource information may be displayed in the second display region 802 by clicking on each control 801. For example, when the fourth control 801 corresponding to the target object “skirt” is clicked on, a plurality of pieces of second sub-resource information matched with the target object “skirt” may be displayed in the second display region 802; when the fourth control 801 corresponding to the target object “bag” is clicked on, a plurality of pieces of second sub-resource information matched with the target object “bag” may be displayed in the second display region 802. Based on this way, the second sub-resource information corresponding to different types of target objects may be displayed separately, which is convenient for the user to search for information of interest.

For example, the video-based information display method of the embodiment of the present disclosure may further include: displaying a box selection page in response to a second predetermined operation on the resource page, in which the current image frame is displayed in the box selection page; in response to receiving a box selection operation on the current image frame in the box selection page, obtaining third resource information corresponding to a target object in an image region defined by the box selection operation based on the image region; and displaying the third resource information.

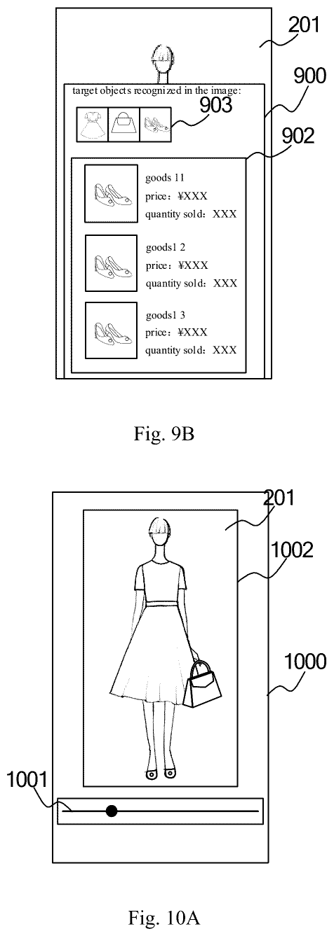

FIG. 9A is a schematic diagram of a box selection page provided by some embodiments of the present disclosure, and FIG. 9B is a schematic diagram of another resource page provided by some embodiments of the present disclosure.

Following the above example, in the case where the user does not find the item of interest in the second resource information shown in FIG. 8, the user may perform a second predetermined operation (for example, a swipe-down operation) on the resource page 800 to jump to a box selection page 900 shown in FIG. 9A, the image frame 201 corresponding to the first event may be displayed on the box selection page 900. When the user performs a box selection operation on a certain region in the image frame 201, a selection box 901 may be displayed and an image region corresponding to the box selection 901 may be sent to the server to inform the server to perform the recognition and search operation on the image region. After the terminal device receives the target object and the third resource information corresponding to the image region, a resource page 900 as shown in FIG. 9B may be displayed, and a new fourth control 903 may be added to the resource page, the newly added fourth control 903 corresponds to a target object in the selection box 901, and a plurality of pieces of third sub-resource information in the third resource information may be displayed in the second display region 902. Based on this way, in the case where the target object of interest to the user is not automatically recognized, the user may perform the manual box selection on the region of interest.

For example, the video-based information display method of the embodiment of the present disclosure may further include: displaying a box selection page in response to a failure of performing an operation of obtaining the second resource information corresponding to the target object in the current image frame or a failure of obtaining the second resource information corresponding to the target object in the current image frame within a predetermined length of time from triggering the first event, in which the current image frame is displayed in the box selection page; in response to receiving a box selection operation on the current image frame in the box selection page, obtaining third resource information corresponding to a target object in an image region defined by the box selection operation based on the image region; and displaying the third resource information.

For example, after the first event on the current image frame is triggered, in the case where a result of the second resource information fed back by the server is empty (that is, the target object in the current image frame is not recognized or the second resource information matched with the target object is not searched) or feedback information from the server for the second resource information has not been received for a long time, the box selection page 900 shown in FIG. 9A may be displayed, and the user may perform manual box selection on the region of interest. Based on this way, the recognition range may be narrowed to a more accurate range by performing manual box selection on the image region, which can speed up the recognition and improve the recognition accuracy to a certain extent.

For example, the video-based information display method of the embodiment of the present disclosure may further include: displaying a progress page in response to a third predetermined operation on the resource page, in which the progress page includes a progress bar control and an image display region, and the current image frame is displayed in the image display region; in response to a fourth predetermined operation on the progress bar control, switching the image display region from displaying the current image frame to displaying a target image frame corresponding to the fourth predetermined operation; obtaining fourth resource information corresponding to a target object in the target image frame; and displaying the fourth resource information.

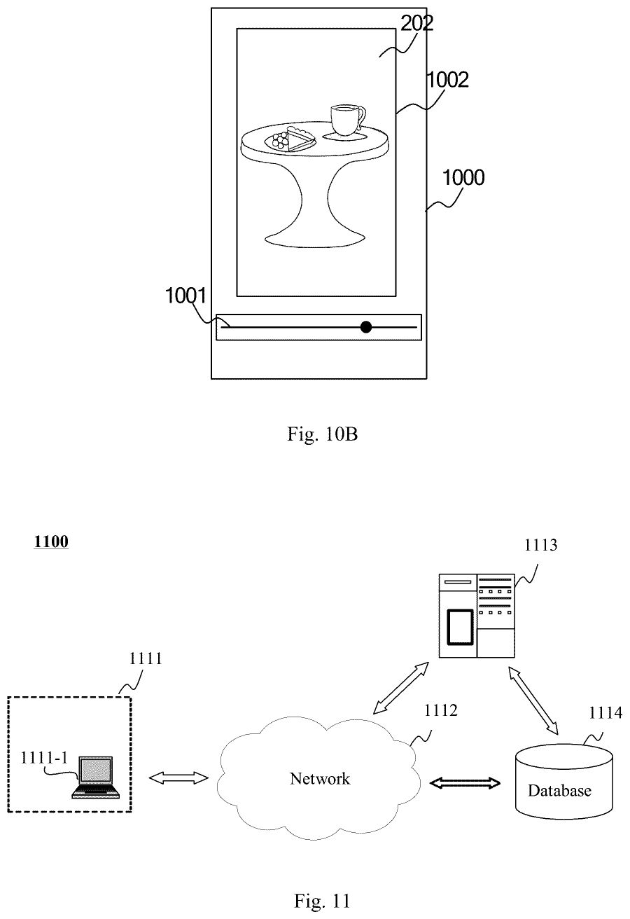

FIG. 10A is a schematic diagram of a progress page provided by some embodiments of the present disclosure, and FIG. 10B is a schematic diagram of another progress page provided by some embodiments of the present disclosure.

For example, following the above example, in the case where a user wants to view the resource information corresponding to other image frames after browsing the second resource information corresponding to the image frame 201 shown in FIG. 8, the user may perform a third predetermined operation (for example, a swipe-down operation) on the resource page 800 to jump to a progress page 1000 shown in FIG. 10A, and the progress page 1000 includes a progress bar control 1001 and an image display region 1002. For example, by sliding a progress bar and the like, a progress value of the progress bar may be changed, and the image display region 1002 may be switched to displaying the image frame corresponding to the progress value. For example, when the image display region 1002 is switched to displaying the image frame 202 by adjusting the progress, the recognition and search operation on the image frame 202 may be triggered to obtain the target object and fourth resource information corresponding to the image frame 202, then the resource page 800 shown in FIG. 8 may be displayed, and the fourth resource information may be displayed on the resource page 800. Based on this way, after browsing the resource information of one image frame, the user does not need to return to the playing page of the target video, but only needs to pull the progress bar to trigger the recognition and search operation on another image frame, so that the operation procedure is simplified.

It is noted that in the embodiment of the present disclosure, the execution order of the various steps of the video-based information display method is not limited, and although the execution process of the various steps is described in a specific order above, this does not constitute a limitation to the embodiment of the present disclosure. The various steps in the video-based information display method may be executed in series or in parallel, which may be determined according to actual requirements. The video-based information display method may further include more or fewer steps, for example, by adding some preprocessing steps to achieve a better display effect, or by storing some intermediate process data for subsequent processing and calculation to omit some similar steps.

FIG. 11 is a system that may be used to implement the video-based information display method provided by the embodiment of the present disclosure. As shown in FIG. 11, the system 1100 may include one or more user terminals (i.e., terminal devices) 1111, a network 1112, a server 1113 and a database 1114. For example, the system 1110 may be used to implement the video-based information display method provided by any embodiment of the present disclosure.

For example, the user terminal 1111 is a computer 1111-1. It should be understood that the user terminal 1111 may be any other type of electronic device capable of performing data processing, which may include, but not limited to, a desktop computer, a notebook computer, a tablet computer, a workstation and the like. The user terminal 1111 may also be any equipment provided with an electronic device. The embodiments of the present disclosure do not limit hardware configuration or software configuration of the user terminal (for example, the type (such as Windows, MacOS, Android, Harmony OS, etc.) or version of an operating system).

The user may operate an application installed on the user terminal 1111 or a website registered on the user terminal 1111, and the application or website transmits data such as image frames and requests to the server 1113 through the network 1112, and the user terminal 1111 may receive the data transmitted by the server 1113 through the network 1112.

For example, software with a video playing function is installed on the user terminal 1111, and the user plays the target video on the user terminal 1111 by using the video playing function of the software. The user terminal 1111 executes the video-based information display method provided by the embodiment of the present disclosure by running code.

The network 1112 may be a single network, or a combination of at least two different networks, which may be wireless communication networks, wired communication networks, etc. For example, the network 1112 may include, but not limited to, one or a combination of a local area network, a wide area network, a public network, private network, etc.

The server 1113 may be a standalone server, a server group, or a cloud server, and all servers in the server group are connected through wired or wireless networks. The server group may be centralized, such as a data center, or distributed. The server 1113 may be local or remote.

The database 1114 may generally refer to a device with a storage function. The database 1114 is mainly used for storing various data used, generated and outputted by the user terminal 1111 and the server 1113 in running, and may be various types of databases, such as a relational database or a non-relational database. The database 1114 may be local or remote. The database 1114 may include corresponding operating software and various memories, such as random access memory (RAM) and read only memory (ROM). Storage devices mentioned above are just some examples, and the storage devices that may be used by the system 1110 are not limited to this.

The database 1114 may be in interconnection or communication with the server 1113 or a part of the server 1113 via the network 1112, or directly in interconnection or communication with the server 1113, or a combination of the above two modes may be adopted.

In some examples, the database 1114 may be a stand-alone device. In other examples, the database 1114 may also be integrated in at least one of the user terminal 1111 and the server 1113. For example, the database 1114 may be provided on the user terminal 1111 or the server 1113. For another example, the database 1114 may be distributed, with one part being provided on the user terminal 1111 and the other part being provided on the server 1113.

For example, the target video and first resource information or the like may be deployed on the database 1114. When the terminal device needs to play the target video, the user terminal 1111 accesses the database 1114 through the network 1112 and acquires the target video and the first resource information that are stored in the database 1114 through the network 1112. The embodiment of the present disclosure does not limit the type of database, for example, it may be a relational database or a non-relational database.

At least one embodiment of the present disclosure also provides a video-based information display apparatus. By means of the apparatus, off-line recognition can be combined with on-line recognition, so that in a case that the user does not trigger the recognition operation, the resource information recognized and searched offline is displayed to the user, and when the user triggers the recognition and search operations for the image frame of interest, resource information matched with the image frame of interest to the user may be acquired online. The image recognition and search function for the video can be enriched, the operation process can be simplified and the user experience can be improved.

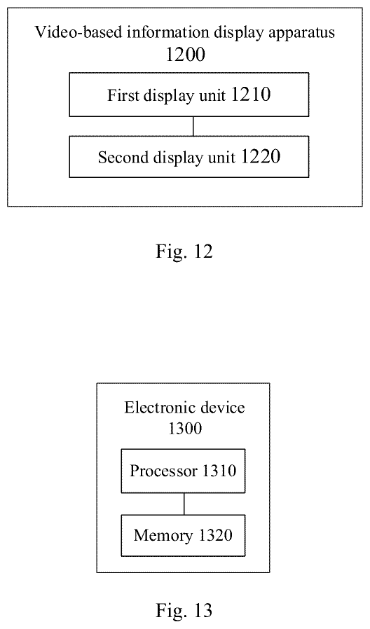

FIG. 12 is a schematic block diagram of a video-based information display apparatus provided by some embodiments of the present disclosure. As shown in FIG. 12, the video-based information display apparatus 1200 includes a first display unit 1210 and a second display unit 1220. For example, the video-based information display apparatus 1200 may be applied to the user terminal, and may also be applied to any device or system that needs to implement video playing and the recognition and search function, and the embodiment of the present disclosure does not limit this.

The first display unit 1210 is configured to, in a process of playing a target video, display, on a playing page of the target video, first resource information corresponding to a target object in the target video, in which the target video includes M image frames, and the first resource information is obtained in advance by matching based on target objects in N image frames. For example, the first display unit 1210 may perform step S110 of the video-based information display method as shown in FIG. 1.

The second display unit 1220 is configured to, in response to triggering a first event in the process of playing the target video, acquire second resource information corresponding to a target object in a current image frame based on at least one current image frame played by the playing page in a process of triggering the first event, and display the second resource information, in which N is an integer greater than 0 and M is an integer greater than or equal to N. For example, the second display unit 1220 may perform steps S120 and S130 of the video-based information display method as shown in FIG. 1.

For example, the first display unit 1210 and the second display unit 1220 may be hardware, software, firmware and any feasible combination thereof. For example, the first display unit 1210 and the second display unit 1220 may be dedicated or universal circuits, chips or apparatuses, or may be a combination of a processor and a memory. The embodiment of the present disclosure does not limit the specific implementation forms of the first display unit 1210 and the second display unit 1220.

It should be noted that in the embodiment of the present disclosure, the various units of the video-based information display apparatus 1200 correspond to the various steps of the above-mentioned video-based information display method, and specific functions of the video-based information display apparatus 1200 may be referred to the above-mentioned description of the video-based information display method, and no details will be repeated here. Components and structures of the video-based information display apparatus 1200 shown in FIG. 12 are only exemplary, and not intended to be limiting, and the video-based information display apparatus 1200 may further include other components and structures as required.

For example, in some examples, the playing page includes a first display region, the first resource information is displayed in the first display region; the first resource information includes N pieces of first sub-resource information respectively corresponding to the target objects in the N image frames. The first display unit 1210 may be further configured to: respectively display the N pieces of first sub-resource information in the first display region when the N image frames are respectively displayed on the playing page.

For example, in some examples, the N image frames include an i-th image frame and a j-th image frame, and the first resource information includes i-th first sub-resource information corresponding to the i-th image frame and j-th first sub-resource information corresponding to the j-th image frame. The first display unit 1210 may be further configured to: in a process of displaying the i-th image frame and an image frame between the i-th image frame and the j-th image frame on the playing page, display the i-th first sub-resource information in the first display region, in which i is an integer greater than 0 and j is an integer greater than i.

For example, in some examples, the M image frames further include a p-th image frame between the i-th image frame and the j-th image frame. The video-based information display apparatus may further include a first image unit, and the first image unit is configured to: in the process of displaying the i-th image frame and an image frame between the i-th image frame and the p-th image frame on the playing page, display, on the first display region, a first scanning graphic that changes as image frames displayed on the playing page change, in which p is an integer greater than i and less than or equal to j.

For example, in some examples, the first graphic unit is further configured to: as the image frames displayed on the playing page change, at least a portion of the first scanning graphic moves in the first display region in a predetermined direction.

For example, in some examples, the video-based information display apparatus may further include a first control unit, and the first control unit is configured to: display a first control on the playing page of the target video in the process of playing the target video. The second display unit 1220 is further configured to: trigger a first predetermined operation on the first control in the process of playing the target video.

For example, in some examples, the second display unit 1220 is further configured to: trigger a playing pause operation on the target video in response to the first event; or trigger a screenshot operation on the playing page of the target video in response to the first event.

For example, in some examples, the video-based information display apparatus may further include a screenshot unit, and the screenshot unit is configured to: display a second control and a third control in response to the screenshot operation on the playing page of the target video, the second control is configured to trigger an operation of displaying the second resource information, and the third control is configured to trigger an operation of sharing the target video to a platform or a user corresponding to the third control.

For example, in some examples, the video-based information display apparatus may further include a second graphic unit, and the second graphic unit is configured to: in a process of obtaining the second resource information, display the current image frame on the playing page, and display a dynamic second scanning graphic superimposed on the current image frame. The dynamic second scanning graphic includes a first sub-scanning graphic moving in a predetermined direction and/or a second sub-scanning graphic moving or flashing at a position of the target object in the current image frame.

For example, in some examples, the second display unit 1220 is further configured to: display a resource page, and display the second resource information in the resource page, the current image frame includes E target objects, the second resource information includes a plurality of pieces of second sub-resource information respectively corresponding to the E target objects, the resource page includes a second display region and E fourth controls respectively corresponding to the E target objects, and each of the fourth controls is configured to trigger an operation of displaying second sub-resource information corresponding to the fourth control in the second display region, and E is an integer greater than 0.

For example, in some examples, the video-based information display apparatus may further include a first box selection unit, and the first box selection unit is configured to: display a box selection page in response to a second predetermined operation on the resource page, in which the current image frame is displayed in the box selection page; in response to receiving a box selection operation on the current image frame in the box selection page, obtain third resource information corresponding to a target object in an image region defined by the box selection operation based on the image region; and display the third resource information.

For example, in some examples, the video-based information display apparatus may further include a second box selection unit, and the second box selection unit is configured to: display a box selection page in response to a failure of performing an operation of obtaining the second resource information corresponding to the target object in the current image frame or a failure of obtaining the second resource information corresponding to the target object in the current image frame within a predetermined length of time from triggering the first event, in which the current image frame is displayed in the box selection page; in response to receiving a box selection operation on the current image frame in the box selection page, obtain third resource information corresponding to a target object in an image region defined by the box selection operation based on the image region; and display the third resource information.

For example, in some examples, the video-based information display apparatus may further include a progress unit, and the progress unit is configured to: display a progress page in response to a third predetermined operation on the resource page, in which the progress page includes a progress bar control and an image display region, and the current image frame is displayed in the image display region; in response to a fourth predetermined operation on the progress bar control, switch the image display region from displaying the current image frame to displaying a target image frame corresponding to the fourth predetermined operation; obtain fourth resource information corresponding to a target object in the target image frame; and display the fourth resource information.

FIG. 13 is a schematic block diagram of an electronic device provided by some embodiments of the present disclosure. As shown in FIG. 13, the electronic device 1300 includes a processor 1310 and a memory 1320. The memory 1320 is configured to store non-temporary computer readable instructions (e.g., one or more computer program modules). The processor 1310 is configured to run the non-temporary computer readable instructions; and the non-temporary computer readable instructions, when run by the processor 1310, may execute one or more steps in the video-based information display method as described above. The memory 1320 and the processor 1310 may be interconnected through a bus system and/or other forms of connection mechanisms (not shown).

For example, the processor 1310 may be a Central Processing Unit (CPU), a Digital Signal Processor (DSP), or other form of processing unit having a data processing capability and/or a program execution capability, for example, a Field Programmable Gate Array (FPGA), etc.; for example, the Central Processing Unit (CPU) may be an X86, or ARM architecture, etc. The processor 1310 may be a general-purpose processor or a special-purpose processor, and may control other components in the electronic device 1300 to execute desired functions.

For example, the memory 1320 may include any combination of one or more computer program products; and the computer program products may include various forms of computer readable storage media, for example, a volatile memory and/or a non-volatile memory. The volatile memory may include, for example, a Random Access Memory (RAM) and/or a cache, or the like. The non-volatile memory may include, for example, a Read Only Memory (ROM), a hard disk, an Erasable Programmable Read Only Memory (EPROM), a portable Compact Disk Read Only Memory (CD-ROM), a USB memory, a flash memory, or the like. One or more computer program modules may be stored on the computer readable storage medium, and the processor 1310 may run the one or more computer program modules, to implement various functions of the electronic device 1300. Various applications and various data, as well as various data used and/or generated by the applications may also be stored on the computer readable storage medium.

It should be noted that in the embodiments of the present disclosure, the above description of the video-based information display method may be referred to for specific functions and technical effects of the electronic device 1300, and no details will be repeated here.

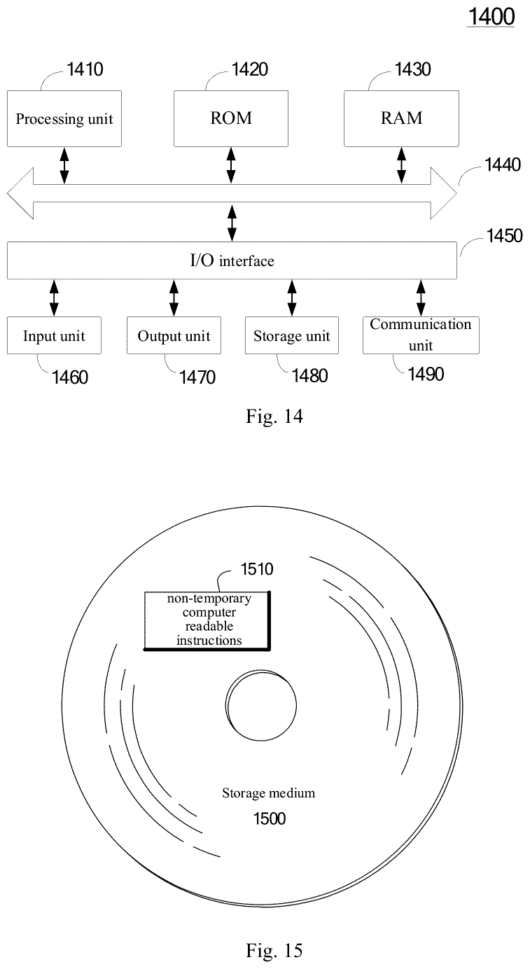

FIG. 14 is a schematic block diagram of another electronic device provided by some embodiments of the present disclosure. The electronic device 1400, for example, is suitable for implementing the video-based information display method provided by the embodiment of the present disclosure. The electronic device 1400 may be a user terminal, or the like. It should be noted that the electronic device 1400 shown in FIG. 14 is only an example and does not impose any limitations on the functionality and scope of use of the embodiments of the present disclosure.

As shown in FIG. 14, the electronic device 1400 may include the processing unit (e.g., a central processing unit (CPU), a graphics processing unit (GPU)) 1410, which may execute various appropriate actions and processing according to programs stored in the read-only memory (ROM)1420 or programs loaded to the random access memory (RAM)1430 from the storage unit 1480. A plurality of programs and data required for the operation of the electronic device 1400 are also stored in the RAM 1430. The processing unit 1410, the ROM 1420 and the RAM 1430 are connected with each other through a bus 1440. An input/output (I/O) interface 1450 is also connected to the bus 1440.

In general, the following units may be connected to the I/O interface 1450: an input unit 1460 including a touch screen, a touch pad, a keyboard, a mouse, a camera, a microphone, an accelerometer, a gyroscope or the like; an output unit 1470 including a liquid crystal display (LCD), a loudspeaker, a vibrator or the like; a storage unit 1480 including a magnetic tape and a hard disk; and a communication unit 1490. The communication unit 1490 may allow the electronic device 1400 to communicate wirelessly in a wired manner with other electronic devices to exchange data. Although FIG. 14 shows the electronic device 1400 including a plurality of units, it should be understood that not all the shown units are required to be implemented or included. The electronic device 1400 may alternatively implement or include more or less units.

For example, according to the embodiments of the present disclosure, the video-based information display method may be implemented as computer software programs. For instance, the embodiment of the present disclosure provides a computer program product, which includes computer programs hosted on a non-transient computer readable medium. The computer programs contain program codes for executing the above video-based information display method, in such an embodiment, the computer programs may be unloaded and installed from the internet through the communication unit 1490, or installed from the storage unit 1480, or installed from the ROM 1420. The functions defined in the video-based information display method provided by the embodiment of the present disclosure are executed when the computer programs are executed by the processing unit 1410.

At least one embodiment of the present disclosure provides a storage medium, configured to store non-temporary computer readable instructions, the non-temporary computer readable instructions, when executed by a computer, implement the video-based information display method according to any embodiment of the present disclosure.

FIG. 15 is a schematic diagram of a storage medium provided by some embodiments of the present disclosure. As shown in FIG. 15, the storage medium 1500 is configured to store non-temporary computer readable instructions 1510. For example, the non-temporary computer readable instructions 1510, when executed by a computer, implement one or more steps of the video-based information display method according to the foregoing.

For example, the storage medium 1500 may be applied in the electronic device 1300 described above. For example, the storage medium 1500 may be the memory 1320 in the electronic device 1300 shown in FIG. 13. For example, a related description of the storage medium 1500 may be referred to the corresponding description of the memory 1320 in the electronic device 1300 shown in FIG. 13 and will not be repeated herein.

In the foregoing, a video-based information display method, a video-based information display apparatus, an electronic device, a storage medium, and a program product provided by embodiments of the present disclosure are described with reference to FIGS. 1 to 15. The video-based information display method provided by embodiments of the present disclosure can combine off-line recognition with on-line recognition, so that in a case that the user does not trigger the recognition and search operation, the resource information recognized and searched offline is displayed to the user, and when the user triggers the recognition and search operation on the image frame of interest, resource information matched with the image frame of interest to the user may be acquired online. The image recognition and search function for the video can be enriched, the operation process can be simplified and the user experience can be improved.

It should be noted that the above storage medium (computer readable medium) of the present disclosure may be a computer readable signal medium, a non-transitory computer readable storage medium, or any combination of the above. The non-transitory computer readable storage medium, for instance, may be, but not limited to, electrical, magnetic, optical, electromagnetic, infrared, or semiconductor system, device, or equipment, or a combination of the above. A more specific example of the non-transitory computer readable storage medium may include but not limited to: electrical connection having one or more wires, portable computer disk, hard disk, random access memory (RAM), read-only memory (ROM), erasable programmable read-only memory (EPROM), flash memory, optical fiber, portable compact disk read-only memory (CD-ROM), optical storage unit, magnetic storage unit, or any suitable combination of the above. In the present disclosure, the non-transitory computer readable storage medium may be any tangible medium containing or storing programs. The programs may be used by a command execution system, device or unit or used in combination with the command execution system, device or unit. However, in the present disclosure, the computer readable signal medium may include data signals propagated in baseband or as part of carrier, in which computer readable program codes are hosted. The propagated data signals may adopt a plurality of forms, including but not limited to electromagnetic signals, optical signals or any suitable combination of the above. The computer readable signal medium may also be any computer readable medium except the non-transitory computer readable storage medium. The computer readable signal medium can send, propagate or transmit programs used by the command execution system, device or unit or used in combination with the command execution system, device or unit. The program codes contained in the computer readable medium can be transmitted by any appropriate medium, including but not limited to: wire, optical cable, radio frequency (RF) and the like, or any suitable combination of the above.

In some embodiments, the client and the server may communicate by utilization of any network protocol which is currently known or developed in the future such as Hyper Text Transfer Protocol (HTTP), and may be interconnected with digital data communication (e.g., communication network) in any form or medium. The example of the communication network includes local area network (LAN), wide area network (WAN), internet, end-to-end network (e.g., ad hoc end-to-end network), and any network which is current known or developed in the future.

The above computer readable medium may be contained in the above electronic device and may also exist alone and not be assembled into the electronic device.

The above computer readable medium hosts one or more programs. When the above one or more programs are executed by the electronic device, the electronic device is configured to: in a process of playing a target video, display, on a playing page of the target video, first resource information corresponding to a target object in the target video, in which the target video includes M image frames, and the first resource information is obtained in advance by matching based on target objects in N image frames; in response to triggering a first event in the process of playing the target video, acquire second resource information corresponding to a target object in a current image frame based on at least one current image frame played by the playing page in a process of triggering the first event; and display the second resource information.

Computer program codes for performing the operations of the present disclosure may be written in one or more programming languages or a combination thereof. The above programming languages include but not limited to object-oriented programming languages such as Java, Smalltalk and C++, and also include conventional procedural programming languages such as “C” language or similar programming languages. The program codes may be completely executed on a user computer, partially executed on the user computer, executed as a separate package, partially executed on the user computer and partially executed on a remote computer, or completely executed on the remote computer or the server. In the case where the remote computer is involved, the remote computer may be connected to the user computer through any kind of network, such as a Local Area Network (LAN) or a Wide Area Network (WAN), or, alternatively, may be connected to an external computer (for instance, connected via the Internet by utilization of Internet service providers).

The flowcharts and the block diagrams in the drawings show possible architectures, functions and operations of the system, the method and the computer program product according to the embodiments of the present disclosure. In this regard, each block in the flowchart or the block diagram may represent a module, a program segment, or a part of code. The module, the program segment, or the part of the code contains one or more executable instructions for implementing specified logic functions. It should be also noted that in some alternative implementations, the functions marked in the blocks may also occur in a different order from those marked in the drawings. For instance, two consecutive blocks may actually be executed basically in parallel, and sometimes, may also be executed in a reverse order, determined by involved functions. It should be also noted that each block in the block diagram and/or the flowchart and the combination of the blocks in the block diagram and/or the flowchart may be implemented by a dedicated hardware-based system that performs a specified function or operation, and may also be implemented by the combination of a special hardware and computer instructions.

Units involved in the embodiments of the present disclosure may be implemented by software, and may also be implemented by hardware. Wherein, the name of the unit should not define the unit under certain circumstances.

The functions described above in this document may be at least partially executed by one or more hardware logical units. For instance, without limitation, demonstration type hardware logical units that may be used include: field programmable gate array (FPGA), application-specific integrated circuit (ASIC), application specific standard parts (ASSP), system on a chip (SOC), complex programmable logic device (CPLD), etc.

In the present disclosure, the machine readable medium may be a tangible medium and may include or store programs used by command execution system, device or equipment or used in combination with the command execution system, device or equipment. The machine readable medium may be a machine readable signal medium or a machine readable storage medium. The machine readable medium may include but not limited to electronic, magnetic, optical, electromagnetic, infrared, or semiconductor system, device or equipment, or any suitable combination of the above. A more specific example of the machine readable storage medium may include electrical connection based on one or more wires, portable computer disk, hard disk, Random Access Memory (RAM), Read Only Memory (ROM), Erasable Programmable Read Only Memory (EPROM), flash memory, optical fiber, Convenient Compact Disk Read Only Memory (CD-ROM), optical storage unit, magnetic storage unit, or any suitable combination of the above.

The above description is only the explanation of a partial embodiment of the present disclosure and the used technical principle. It should be understood by those skilled in the art that the disclosure scope involved in the disclosure is not limited to the technical solution formed by the specific combination of the above technical features, but also covers other technical solutions formed by any combination of the above technical features or their equivalent features without departing from the above disclosed concept. For example, the technical solution formed by replacing the above features with (but not limited to) technical features with similar functions disclosed in the disclosure.

In addition, although the operations are depicted in a specific order, this should not be understood as requiring these operations to be performed in the specific order shown or in a sequential order. Under certain circumstances, multitasking and parallel processing may be beneficial. Similarly, although several specific implementation details are included in the above discussion, these should not be interpreted as limiting the scope of the present disclosure. Some features described in the context of separate embodiments may also be implemented in a single embodiment in combination. On the contrary, various features described in the context of a single embodiment may also be implemented in a plurality of embodiments alone or in any suitable sub-combination.

Although the subject matter has been described in language specific to structural features and/or logical actions of methods, it should be understood that the subject matter defined in the appended claims is not necessarily limited to the specific features or actions described above. On the contrary, the specific features and actions described above are only example forms of realizing the claims.

1. A video-based information display method, comprising:
in a process of playing a target video, displaying, on a playing page of the target video, first resource information corresponding to a target object in the target video, wherein the target video comprises M image frames, and the first resource information is obtained in advance by matching based on target objects in N image frames;
in response to triggering a first event in the process of playing the target video, acquiring second resource information corresponding to a target object in a current image frame based on at least one current image frame played by the playing page in a process of triggering the first event; and
displaying the second resource information,
wherein N is an integer greater than 0 and M is an integer greater than or equal to N.

2. The method according to claim 1, wherein the playing page comprises a first display region, the first resource information is displayed in the first display region; the first resource information comprises N pieces of first sub-resource information respectively corresponding to the target objects in the N image frames;
the displaying, on a playing page of the target video, first resource information corresponding to a target object in the target video comprises:
respectively displaying the N pieces of first sub-resource information in the first display region when the N image frames are respectively displayed on the playing page.

3. The method according to claim 2, wherein the N image frames comprise an i-th image frame and a j-th image frame, and the first resource information comprises i-th first sub-resource information corresponding to the i-th image frame and j-th first sub-resource information corresponding to the j-th image frame;
the displaying, on a playing page of the target video, first resource information corresponding to a target object in the target video comprises:
in a process of displaying the i-th image frame and an image frame between the i-th image frame and the j-th image frame on the playing page, displaying the i-th first sub-resource information in the first display region,
wherein i is an integer greater than 0 and j is an integer greater than i.

4. The method according to claim 3, wherein the M image frames further comprise a p-th image frame between the i-th image frame and the j-th image frame, the information display method further comprises:
in the process of displaying the i-th image frame and an image frame between the i-th image frame and the p-th image frame on the playing page, displaying, on the first display region, a first scanning graphic that changes as the playing page displays different image frames,
wherein p is an integer greater than i and less than or equal to j.

5. The method according to claim 4, wherein the displaying, on the first display region, a first scanning graphic that changes as the playing page displays different image frames comprises:
as the playing page displays different image frames, at least a portion of the first scanning graphic moves in the first display region in a predetermined direction.

6. The method according to claim 1, further comprising:
in the process of playing the target video, displaying a first control on the playing page of the target video;
wherein the triggering a first event in the process of playing the target video comprises: triggering a first predetermined operation on the first control in the process of playing the target video.

7. The method according to claim 1, wherein the triggering a first event in the process of playing the target video comprises:
triggering a playing pause operation on the target video; or triggering a screenshot operation on the playing page of the target video.

8. The method according to claim 7, further comprising:
displaying a second control and a third control in response to the screenshot operation on the playing page of the target video,
wherein the second control is configured to trigger an operation of displaying the second resource information, and the third control is configured to trigger an operation of sharing the target video to a platform or a user corresponding to the third control.

9. The method according to claim 1, further comprising:
in a process of obtaining the second resource information, displaying the current image frame on the playing page, and displaying a dynamic second scanning graphic superimposed on the current image frame,
wherein the dynamic second scanning graphic comprises a first sub-scanning pattern moving in a predetermined direction and/or a second sub-scanning pattern moving or flashing at a position of the target object in the current image frame.

10. The method according to claim 1, wherein the displaying the second resource information comprises:
displaying a resource page, and displaying the second resource information in the resource page;
wherein the current image frame comprises E target objects, and the second resource information comprises a plurality of pieces of second sub-resource information respectively corresponding to the E target objects,
the resource page comprises a second display region and E fourth controls respectively corresponding to the E target objects, and each of the fourth controls is configured to trigger an operation of displaying second sub-resource information corresponding to the fourth control in the second display region, wherein E is an integer greater than 0.

11. The method according to claim 10, further comprising:
displaying a box selection page in response to a second predetermined operation on the resource page, wherein the current image frame is displayed in the box selection page;
in response to receiving a box selection operation on the current image frame in the box selection page, obtaining third resource information corresponding to a target object in an image region defined by the box selection operation based on the image region; and
displaying the third resource information.

12. The method according to claim 1, further comprising:
displaying a box selection page in response to a failure of performing an operation of obtaining the second resource information corresponding to the target object in the current image frame or a failure of obtaining the second resource information corresponding to the target object in the current image frame within a predetermined length of time from triggering the first event, wherein the current image frame is displayed in the box selection page;
in response to receiving a box selection operation on the current image frame in the box selection page, obtaining third resource information corresponding to a target object in an image region defined by the box selection operation based on the image region; and
displaying the third resource information.

13. The method according to claim 10, further comprising:
displaying a progress page in response to a third predetermined operation on the resource page, wherein the progress page comprises a progress bar control and an image display region, and the current image frame is displayed in the image display region;
in response to a fourth predetermined operation on the progress bar control, switching the image display region from displaying the current image frame to displaying a target image frame corresponding to the fourth predetermined operation;
obtaining fourth resource information corresponding to a target object in the target image frame; and
displaying the fourth resource information.

14. A video-based information display apparatus, comprising:
a first display unit configured to, in a process of playing a target video, display, on a playing page of the target video, first resource information corresponding to a target object in the target video, wherein the target video comprises M image frames, and the first resource information is obtained in advance by matching based on target objects in N image frames;
a second display unit configured to, in response to triggering a first event in the process of playing the target video, acquire second resource information corresponding to a target object in a current image frame based on at least one current image frame played by the playing page in a process of triggering the first event, and display the second resource information;
wherein N is an integer greater than 0 and M is an integer greater than or equal to N.

15. An electronic device, comprising:
a processor; and
a memory comprising one or more computer program modules;
wherein the one or more computer program modules are stored in the memory and configured to be executed by the processor, and the one or more computer program modules comprise instructions for implementing a video-based information display method and the video-based information display method comprises:
in a process of playing a target video, displaying, on a playing page of the target video, first resource information corresponding to a target object in the target video, wherein the target video comprises M image frames, and the first resource information is obtained in advance by matching based on target objects in N image frames;
in response to triggering a first event in the process of playing the target video, acquiring second resource information corresponding to a target object in a current image frame based on at least one current image frame played by the playing page in a process of triggering the first event; and
displaying the second resource information,
wherein N is an integer greater than 0 and M is an integer greater than or equal to N.

16. A computer-readable storage medium for storing non-transitory computer-readable instructions, non-transitory computer-readable instructions, when executed by a computer, implement the video-based information display method according to claim 1.

17. (canceled)

18. The method according to claim 2, further comprising:
in the process of playing the target video, displaying a first control on the playing page of the target video;
wherein the triggering a first event in the process of playing the target video comprises: triggering a first predetermined operation on the first control in the process of playing the target video.

19. The method according to claim 2, wherein the triggering a first event in the process of playing the target video comprises:
triggering a playing pause operation on the target video; or
triggering a screenshot operation on the playing page of the target video.

20. The method according to claim 2, further comprising:
in a process of obtaining the second resource information, displaying the current image frame on the playing page, and displaying a dynamic second scanning graphic superimposed on the current image frame,
wherein the dynamic second scanning graphic comprises a first sub-scanning pattern moving in a predetermined direction and/or a second sub-scanning pattern moving or flashing at a position of the target object in the current image frame.

21. The method according to claim 2, wherein the displaying the second resource information comprises:
displaying a resource page, and displaying the second resource information in the resource page;
wherein the current image frame comprises E target objects, and the second resource information comprises a plurality of pieces of second sub-resource information respectively corresponding to the E target objects,
the resource page comprises a second display region and E fourth controls respectively corresponding to the E target objects, and each of the fourth controls is configured to trigger an operation of displaying second sub-resource information corresponding to the fourth control in the second display region,
wherein E is an integer greater than 0.
